(19) United States
(12) Patent Application Publication
(10) Pub. No.: US 2025/0294598 A1
(43) Pub. Date: Sep. 18, 2025

(54) METHODS AND APPARATUS FOR CO-CHANNEL CO-EXISTENCE OF NR AND LTE V2X SYSTEMS

(71) Applicant: INTERDIGITAL PATENT HOLDINGS, INC., Wilmington, DE (US)

(72) Inventors: Tao Deng, New York, NY (US); Aata El Hamss, Laval (CA); Tuong Hoang, Montreal (CA); Moon IL Lee, Melville, NY (US)

(73) Assignee: INTERDIGITAL PATENT HOLDINGS, INC., Wilmington, DE (US)

(21) Appl. No.: 18/860,134

(22) PCT Filed: Apr. 26, 2023
(86) PCT No.: PCT/US2023/019935

§ 371 Date: Oct. 25, 2024

Related U.S. Application Data
(60) Provisional application No. 63/334,988, filed on Apr. 26, 2022.
(60) Provisional application No. 63/394,757, filed on Aug. 3, 2022.

(51) Int. Cl. H04W 72/40; H04B 17/318; H04L 1/1812

(52) U.S. Cl. CPC H04W 72/40; H04B 17/328; H04L 1/1812

(57) ABSTRACT

A WTRU may be configured to receive configuration information regarding a LTE sidelink (SL) resource pool and a NR SL resource pool. The WTRU may be configured to determine an association between time and frequency resources of the LTE SL resource pool and time and frequency resources of the NR SL resource pool. The WTRU may be configured to select NR SL candidate resources, from the NR SL resource pool. for a hybrid automatic repeat request (HARQ)-enabled NR SL transmission. The WTRU may be configured to receive reservation information indicating LTE time and frequency resources of the LTE SL resource pool. The WTRU may be configured to determine a NR SL physical SL feedback channel (PSFCH) resource corresponding to each NR SL candidate resource of the selected NR SL candidate resources. The WTRU may be configured to exclude a NR SL candidate resource from the selected NR SL candidate resources.

### CROSS-REFERENCE TO RELATED APPLICATIONS

This application claims the benefit of U.S. Provisional Application No. 63/334,988, filed Apr. 26, 2022 and U.S. Provisional Application No. 63/394,757 filed Aug. 3, 2022, the contents of which are incorporated herein by reference

### BACKGROUND

Side link (SL) operations may co-exist in Long Term Evolution (LTE) and New Radio (NR) with co-channels (e.g., same channels) or not co-channels (e.g., adjacent channels or channels separated sufficiently far away from each other). In co-channel deployment, LTE and NR SL transmission/reception may overlap within a device. In non-co-channel deployment, LTE and NR SL transmission may collide with each other within a device. Thus, methods and apparatuses that enable LTE and NR spectrum sharing and maximum deployment flexibility for co-channel co-existence of LTE and NR are needed.

### SUMMARY

A method and wireless transmit/receive unit (WTRU) for NR SL resource selection is disclosed. A WTRU may be configured to receive configuration information regarding a Long Term Evolution (LTE) sidelink (SL) resource pool and a New Radio (NR) SL resource pool. The WTRU may be configured to determine an association between time and frequency resources of the LTE SL resource pool and time and frequency resources of the NR SL resource pool. The WTRU may be configured to select NR SL candidate resources, from the NR SL resource pool, for a hybrid automatic repeat request (HARQ)-enabled NR SL transmission. The WTRU may be configured to receive reservation information indicating LTE time and frequency resources of the LTE SL resource pool. The WTRU may be configured to determine a NR SL physical SL feedback channel (PSFCH) resource corresponding to each NR SL candidate resource of the selected NR SL candidate resources. The WTRU may be configured to exclude a NR SL candidate resource from the selected NR SL candidate resources. Time and frequency resources of the excluded NR SL candidate resource may overlap with the indicated LTE time and frequency resources or time and frequency resources of the determined NR SL PSFCH resource may overlap with the indicated LTE time and frequency resources. The WTRU may be configured to exclude a NR SL candidate resource from the selected NR SL candidate resources based on a priority of a NR SL transport block or a priority of the indicated LTE time and frequency resources. The WTRU may be configured to select a NR SL resource within remaining NR SL candidate resources. The WTRU may be configured to transmit information in a NR SL physical sidelink shared channel (PSSCH) transmission in the selected NR SL resource. The received configuration information may comprise LTE SL sub-carrier spacing information, NR SL sub-carrier spacing information, a number of physical resource blocks (PRBs) for an LTE SL sub-channel, a number of PRBs for a NR SL sub-channel, LTE SL synchronization signal (SSS) resource configuration information, and NR SL PSFCH resource configuration information. The determining an association between time and frequency resources of the LTE SL resource pool and time and frequency resources of the NR SL resource pool may be based on the received configuration information. The association may comprise an association between an LTE SL subframe and one or more NR SL slots, and an association between an LTE SL sub-channel and one or more NR SL sub-channels. The association may comprise a logical index of an LTE SL sub-frame to one or more indices of one or more NR SL slots, and an index of an LTE SL sub-channel to one or more NR SL sub-channels. Time and frequency resources of the excluded NR SL candidate resource may overlap with time and frequency resources of an LTE SL synchronization signal (SSS). The selecting NR SL candidate resources may be in response to received trigger information. The receiving reservation information indicating LTE time and frequency resources may be based on LTE sensing. Determining a NR SL PSFCH resource corresponding to each NR SL candidate resource may be based on the NR PSFCH resource configuration information. The reservation information indicating LTE time and frequency resources may comprise LTE SL synchronized signal block (SSB) resources, received LTE SSB reference signal receive power (RSRP), resources reserved for an LTE V2X transmission by the WTRU, resources reserved for an LTE V2X transmission intended for the WTRU, resources reserved for an LTE V2X transmission not intended for the WTRU, and RSRPs for the resources reserved for the LTE V2X transmission not intended for the WTRU.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example method for LTE side link (SL) resource exclusion in a NR SL resource (re)selection;

FIG. 3 shows an example method for pre-emptive LTE SL resource exclusion in a NR SL slot;

FIG. 4 shows an example method for performing resource selection considering LTE V2X resource reservation;

FIG. 5 shows an example method for performing detection of conflict between LTE and NR V2X transmission; and

FIG. 6 shows an example method for performing NR SL resource selection.

### DETAILED DESCRIPTION

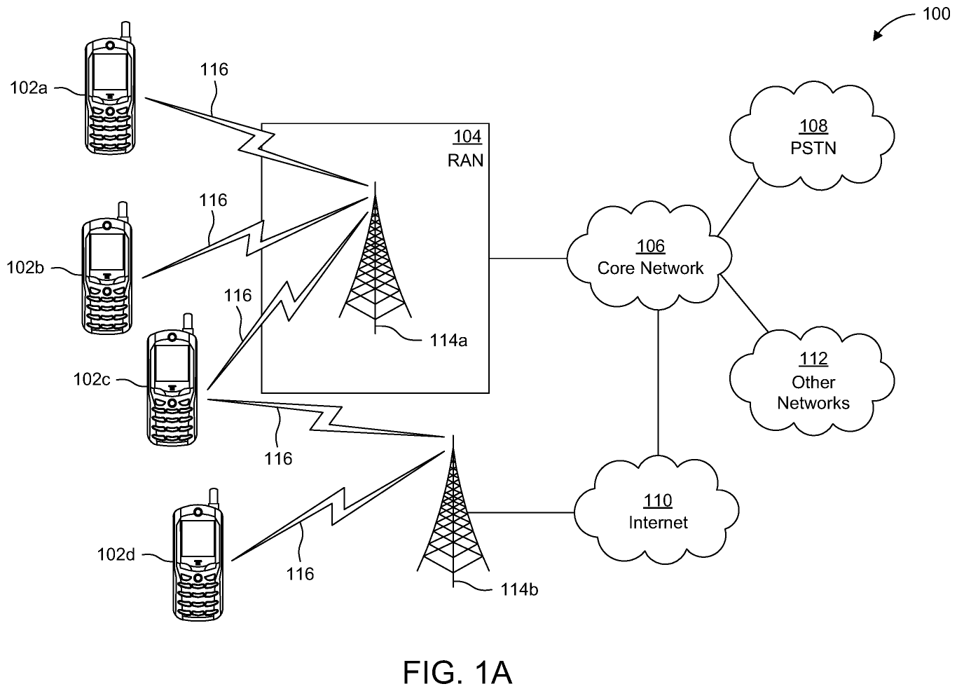

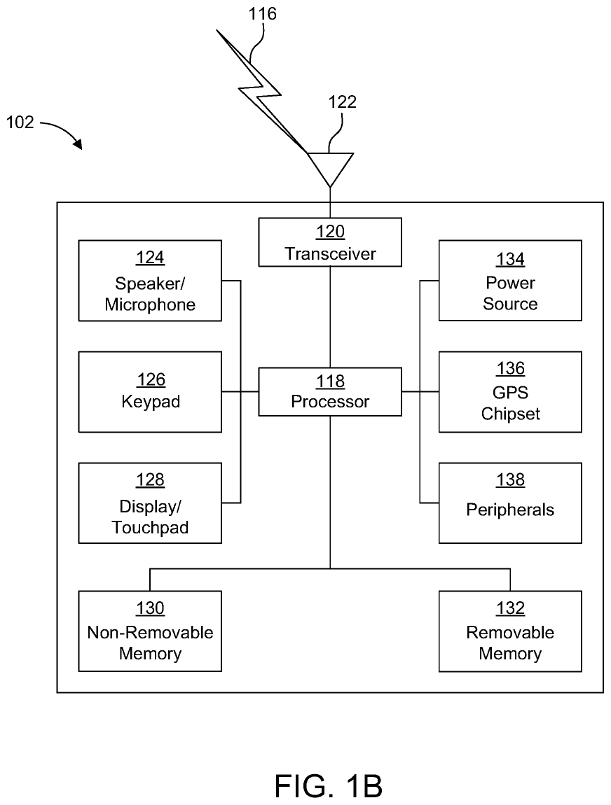

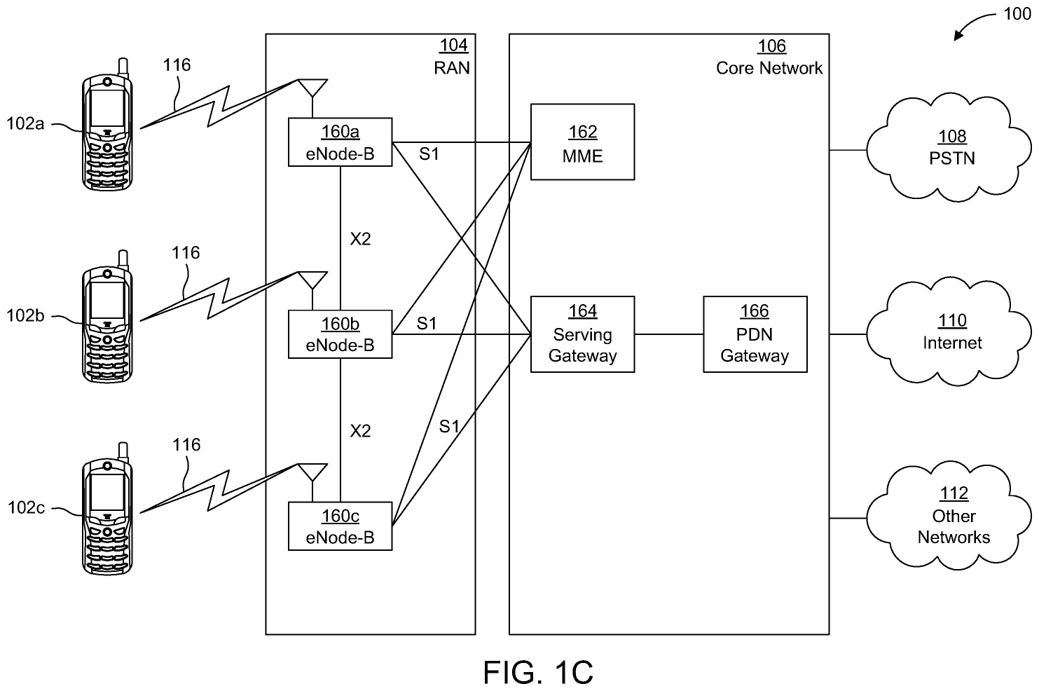

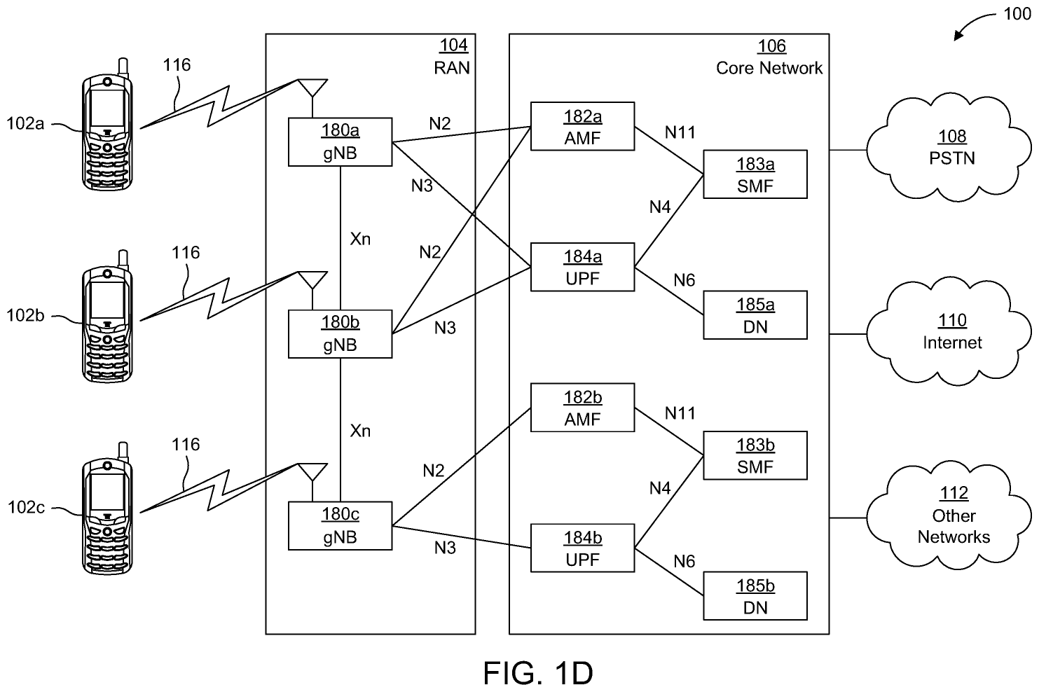

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Embodiments for not-co-channel co-existence of NR and LTE SL operations are described herein.

In NR, co-existence between LTE and NR SL operations may be implemented from a WTRU perspective given the half-duplex constraint and incoordination between LTE and NR SL operations. As a result, for NR V2X in-device co-existence SL technologies may be developed for a “not co-channel” scenario, in which NR and LTE SL co-exist in different channels, for example, adjacent channels or channels separated sufficiently far away from each other.

Examples in R16 NR V2X may include, but are not limited to, short-term Time-Division Multiplexing (TDM), long-term TDM and Frequency Division Multiplexing (FDM).

For the long-term TDM, LTE and NR SL may be (pre)configured with dedicated resources, for example, resource pools.

For the short-term TDM, a WTRU may determine dynamically which of LTE and NR SL to operate based on the priority information available a time period (T) before the earliest transmission. The time period (T) may be specified as less than 4 ms or the like, and how this priority information becomes available for both LTE and NR SL radio access may be specified as WTRU implementation.

For the FDM, a WTRU may perform dynamic sharing of power between LTE and NR intra-band and inter-band SL.

In SL evolution (SLE), the co-channel co-existence may enable LTE and NR spectrum sharing and maximum deployment flexibility.

Overlapping in-device NR and LTE SL transmission/reception is described herein.

In a co-channel deployment, a WTRU may be (pre)configured with overlapping time and frequency resources for NR and LTE operations. From an in-device co-existence perspective, the interference between LTE and NR SL radio access within a WTRU can be overlapping and more severe than a “not co-channel” scenario. The short-term TDM methods may be re-used, but with both “not co-channel” and “co-channel” operations supported, more packets will be dropped. In addition, the prioritization technology relies on a priori knowledge, for example, a reserved LTE or NR reception, but with aperiodic transmissions supported by NR SL, a WTRU will not have this information and when the WTRU has a LTE SL transmission to perform, it will not perform any prioritization and will miss any NR SL aperiodic reception in the slots.

Collisions between NR and LTE SL transmission are described herein.

In “not co-channel” deployment, an in-device interference case of LTE SL RX and NR SL RX may not be considered, because the resources of the receptions are not overlapping, and a WTRU is able to receive such two transmissions simultaneously without performing short-TDM prioritization. This may not apply to a “co-channel” scenario, when the two overlapping LTE and NR SL transmissions arrive at one WTRU, they will interfere with each other and the WTRU can only receive one of them or neither depending on the relative received levels. This collision between NR and LTE SL transmissions may need to be resolved in NR SL.

Embodiments for NR Mode 2 resource selection with LTE V2X resource reservation information are described herein.

Embodiments for WTRU's determination of resources reserved by LTE V2X operations in a NR SL resource pool and LTE SL resource pool are described herein.

A WTRU may be (pre)configured with a set of LTE SL resource pools and NR SL resource pools. A WTRU may be (pre)configured with one or more resources for LTE SL synchronization signal transmission and reception. The LTE SL synchronization signal may include a Primary Sidelink Synchronization Signal (PSSS) and a Secondary Sidelink Synchronization Signal (SSSS). A WTRU may determine a set of LTE SL logical subframes of a resource pool and index the logical subframes in ascending order with an SFN cycle. The logical subframes (pre)configured for PSSS/SSSS may not be included in an LTE SL resource pool. In a frequency domain, a WTRU may be (pre)configured with a number of sub-channels for a resource pool and each sub-channel may include a (pre)configured number of RBs. A WTRU may perform resource selection and transmission of an LTE PSSCH within one logical subframe (1 ms) over one or more such sub-channels. Such an LTE PSSCH resource may be referred as a single-subframe LTE SL resource.

Embodiments for NR SL resource pool are described herein.

A WTRU may determine a set of NR logical slots of a resource pool and index the logical slots in ascending order within an SFN cycle. In a frequency domain, a WTRU may be (pre)configured with a number of sub-channels for a resource pool and each sub-channel may include a (pre)configured number of RBs. A WTRU may perform resource selection and transmission of a NR PSSCH within a one logical slot over one or more such sub-channels. The duration of one logical slot may depend on the subcarrier spacing (SCS) of the NR SL BWP and equal to 2^{-u}, where the numerology index (u)=0, 1 and 2 for SCS of 15 kHz, 30 kHz and 60 kHz, respectively. Such a NR PSSCH resource may be referred as a single-slot NR SL resource.

Embodiments for WTRU determination of overlapping mapping between NR SL and LTE SL resource pools are described herein.

A WTRU may determine one or more LTE SL resource pool overlapping in time and/or frequency with a NR SL resource pool based on the resource pool (pre)configuration. For each overlapping LTE SL resource pool, a WTRU may determine a mapping between the overlapping resources, for example, between an index of an LTE SL subframe and one or more index(es) of NR SL slot(s), and between an index of LTE SL sub-channel and one or more index(s) of NR SL sub-channel(s). The determination of such a mapping may be based on one or more of the following: (1) the numerology (pre)configured for the LTE SL and NR SL resource pool; (2) the physical subframe corresponding to an LTE SL logical subframe and physical slot corresponding to NR SL logical slot; and (3) the starting RB, number of RBs per sub-channel and number of sub-channels (pre)configured for the LTE SL and NR SL resource pool.

A WTRU may determine an overlapping between an LTE SL logical subframe and a NR SL logical slot when the corresponding physical subframe and slot overlap in time. A WTRU may determine a mapping between an index of an LTE SL subframe and index(s) of NR SL slot(s) overlapping with the LTE SL sub-frame. A WTRU may map one or more NR SL slot index(es) to an LTE SL subframe index when the numerology of NR and LTE SL resource pool may be different. It is noted that LTE SL may support 15 kHz and NR SL may support multiple subcarrier spacings (SCSs) including 15 kHz, 30 kHz and 60 kHz. A WTRU may determine the number of NR SL logical slots in a NR SL resource pool that may overlap with LTE SL logical subframes in an LTE SL resource pool.

In a frequency domain, a WTRU may determine a mapping between index(s) of LTE SL sub-channels and index(es) of overlapping SL sub-channels. As the starting RB, number of RBs per sub-channel and number of sub-channels (pre)configured for LTE SL and NR SL resource pool may be different, the index of one LTE SL sub-channel may be mapped to one or more NR SL sub-channels or vice versa.

In a (pre)configured NR SL resource pool, a WTRU may determine a set of NR SL resources that may overlap in time and frequency with LTE SL resource(s) in one or more (pre)configured LTE SL resource pool(s). A NR SL resource may comprise a NR SL slot and a NR SL sub-channel. A LTE SL resource may comprise a LTE SL subframe and a LTE SL sub-channel.

When the SCS of both NR and LTE SL resources is 15 kHz, the time duration of a NR SL slot and a LTE SL subframe may be the same. When the SCS of NR SL resource is larger than 15 kHz (e.g., 30 kHz and 60 kHz), the time duration of a NR SL slot may be a fraction of a LTE SL subframe. In a frequency domain, depending on the number of RBs (pre)configured for a sub-channel in a LTE SL and NR SL resource pool, a NR SL sub-channel may overlap with one or more LTE SL sub-channels.

Thus, a NR SL resource may overlap with one or more LTE SL resource and vice versa depending on the SCS and sub-channel (pre)configurations. Accordingly, a WTRU may determine a NR SL resource Rᵢⱼ, where i is the NR SL logical slot index and j is the NR SL sub-channel index, may overlap with one or more LTE SL resource(s) (i.e. become an NR SL overlapping resource) when both of the following conditions are met: the NR SL slot i overlaps with one or more LTE subframe(s); and the NR sub-channel j overlaps with one or more LTE sub-channel(s).

A WTRU may determine a set of such overlapping resources within a NR SL resource pool, which may also be referred as an overlapping resource set. A WTRU may determine the remaining NR SL resources in a NR SL resource pool as non-overlapping resources in the NR SL resource pool.

A WTRU may determine an availability of an overlapping resource set within a NR SL resource pool for NR SL PSSCH/PSCCH transmissions for a NR SL application. For example, a WTRU may determine whether an overlapping resource set within a NR SL resource pool may be available for NR SL PSSCH/PSCCH transmissions for NR SL application(s) based on one or more of the following: the number of NR SL resources in the overlapping resource set in the NR SL resource pool; QoS requirement(s) of the NR SL application(s) (e.g., priority of the SL TBs associated with the NR SL application(s)); CBR and/or RSSI measurement of the NR SL resource pool; CBR and/or RSSI measurement of LTE SL resource pool(s) overlapping with the NR SL resource pool; CBR and/or RSSI measurement of the overlapping resources within the NR SL resource pool; CBR and/or RSSI measurement of the non-overlapping resources within the NR SL resource pool; LTE SL sensing result of the overlapping LTE SL resource pool(s); and/or LTE SCI decoding information.

A WTRU may measure a SL RSSI of a sub-channel as the linear average of the total received power measured over OFDM symbols (excluding the 1^{st} AGC symbol) in a NR SL slot or a LTE subframe. A SL RSSI may thus indicate an analogue energy level in a sub-channel.

Embodiments for CBR and/or RSSI measurement of the NR SL resource pool are described herein. A WTRU may perform a NR SL resource pool CBR measurement specific to a NR SL resource pool in a NR SL slot (n). A WTRU may compute within a CBR measurement window a NR SL resource pool CBR value as the ratio of sub-channels in the NR SL resource pool whose measured SL RSSI may exceed a (pre-)configured threshold to the total number of sub-channels (pre)configured in the NR SL resource pool. The CBR measurement window may be (pre)configured to start in slot (n−a) and end in slot (n−1), where a may be (pre)configured, for example 100 NR SL slots.

A WTRU may perform a NR SL resource pool RSSI measurement specific to a NR SL resource pool in a NR SL slot (n). A WTRU may compute within a RSSI measurement window a NR SL resource pool RSSI value as an average and/or filtered RSSI value over all sub-channels (pre)configured in the resource pool. A WTRU may be (pre)configured with a filtering co-efficient for the RSSI filtering within the RSSI measurement window. The RSSI measurement window may be (pre)configured to start in slot (n−a) and end in slot (n−1), where a may be (pre)configured, for example 100 NR SL slots.

The CBR and RSSI measurement of a NR resource pool indicates the level of utilization of the NR resource pool. A large CBR and RSSI value may indicate a higher level of use of the resources by NR SL transmissions and potentially LTE SL transmissions over the overlapping resources. The measurement does not indicate the level of LTE SL and/or NR SL transmission activities specific to the overlapping resources.

Embodiments related to CBR and/or RSSI measurement of LTE SL resource pool(s) overlapping with the NR SL resource pool are described herein. A WTRU may perform a LTE SL resource pool CBR measurement specific to a LTE SL resource pool in a NR SL slot (n). A WTRU may compute within a CBR measurement window a LTE SL resource pool CBR value as the ratio of sub-channels in the LTE SL resource pool whose measured SL RSSI may exceed a (pre-)configured threshold to the total number of sub-channels (pre)configured in the LTE SL resource pool. The CBR measurement window may include a (pre)configured number of LTE subframes. The applied sub-channel and subframe may be (pre)configured for the LTE SL resource pool.

A WTRU may perform a LTE SL resource pool RSSI measurement specific to a LTE SL resource pool in a NR SL slot (n). A WTRU may compute within a RSSI measurement window a LTE SL resource pool RSSI value as an average and/or filtered RSSI value over all sub-channels (pre)configured in the resource pool. A WTRU may be (pre)configured with filtering co-efficient for the RSSI filtering within the RSSI measurement window. The RSSI measurement window may include a (pre)configured number of LTE subframes. The applied sub-channel and subframe may be (pre)configured for the LTE SL resource pool.

The CBR and RSSI measurement of a LTE resource pool overlapping with the NR resource pool may provide the information regarding the level of utilization of the LTE SL resource pool. A large CBR and RSSI value may indicate a higher level of use of the resources by LTE SL transmissions and potentially NR SL transmissions over the overlapping resources. The measurement does not indicate the level of LTE SL and/or NR SL transmission activities specific to the overlapping resources.

Embodiments related to a WTRU performing CBR and/or RSSI measurement of the overlapping resources within the NR SL resource pool are described herein. For example, a WTRU may perform an overlapping resource CBR measurement specific to a determined overlapping resource set in a NR SL resource pool in NR SL slot (n). A WTRU may compute within a CBR measurement window an overlapping resource CBR value as the ratio of sub-channels in the overlapping resource set whose measured SL RSSI may exceed a (pre-)configured threshold to the total number of sub-channels in the overlapping resource set. In an embodiment, the RSSI measurement window may include a (pre)configured number of LTE subframes. The applied sub-channel and subframe may be (pre)configured for the LTE SL resource pool.

A WTRU may perform an overlapping resource RSSI measurement specific to a determined overlapping resource set in a NR SL resource pool in NR SL slot (n). A WTRU may compute within a RSSI measurement window an overlapping resource RSSI value as an average and/or filtered RSSI value over all sub-channels in the overlapping resource set. A WTRU may be (pre)configured with a filtering co-efficient for the RSSI filtering within the RSSI measurement window. The RSSI measurement window may include a (pre)configured number of LTE subframes. The applied sub-channel and subframe may be (pre)configured for the LTE SL resource pool.

The CBR and RSSI measurement of the overlapping resources within a NR resource pool provides the information regarding the level of utilization specific to the overlapping NR SL resources. A large CBR and RSSI value may indicate a higher level of use of the resources by LTE SL transmissions and/or NR SL transmissions.

Embodiments related to a WTRU performing CBR and/or RSSI measurements of the non-overlapping resources within the NR SL resource pool are described herein. For example, a WTRU may perform a NR SL non-overlapping resource CBR measurement specific to NR SL non-overlapping resources in a NR SL resource pool in NR SL slot (n). A WTRU may compute within a CBR measurement window a NR SL non-overlapping resource CBR value as the ratio of sub-channels of the NR SL non-overlapping resources whose measured SL RSSI may exceed a (pre-)configured threshold to the total number of sub-channels of the non-overlapping resources. The CBR measurement window may be (pre)configured to start in slot (n−a) and end in slot (n−1), where a may be (pre)configured, for example 100 NR SL slots.

A WTRU may perform a NR SL non-overlapping resource RSSI measurement specific to NR SL non-overlapping resources in a NR SL resource pool in NR SL slot (n). A WTRU may compute within a RSSI measurement window a NR SL resource pool RSSI value as an average and/or filtered RSSI value over all sub-channels (pre)configured in the resource pool. A WTRU may be (pre)configured with a filtering co-efficient for the RSSI filtering within the RSSI measurement window. The RSSI measurement window may be (pre)configured to start in slot (n−a) and end in slot (n−1), where a may be (pre)configured, for example 100 NR SL slots.

In an example, the CBR and RSSI measurement of the non-overlapping resources within a NR resource pool indicates the level of activity (i.e., utilization by NR SL transmissions of these specific resources in a NR resource pool). A large CBR and RSSI value may indicate a higher level of use of these resources by NR SL transmissions.

Embodiments related to a WTRU performing CBR and/or RSSI measurements and resource reservation information based on LTE sensing related to the non-overlapping resources within the NR SL resource pool are described herein.

In an embodiment, when a WTRU performs such an evaluation in an NR SL slot (n), the WTRU may derive the following based on a LTE resource selection procedure (i.e., sensing) performed in a LTE SL resource pool in LTE SL subframe (m): (1) CBR measurement within a (pre)configured window between LTE SL subframe (m−1) and (m−a) where a may be (pre)configured; (2) RSSI measurement within a (pre)configured window between LTE SL subframe (m−1) and (m−a) where a may be (pre)configured; (3) RSRP measurement within a (pre)configured window between LTE SL subframe (m−1) and (m−a) where a may be (pre)configured; (4) a set of available LTE SL resources (e.g., Set A); and/or (5) a set of excluded and unavailable resources not available (i.e., reserved for LTE SL transmissions).

Such a LTE SL sensing procedure may be triggered by the evaluation of the overlapping resources in a NR SL resource pool. In an example, a WTRU may apply the result from a LTE SL sensing performed within a period preceding the evaluation (e.g., when a WTRU performs an evaluation in NR SL slot (n), the time period between the LTE SL subframe (m) and NR slot (n) may be smaller than a (pre)configured threshold). This will ensure the LTE sensing result is up-to-date.

Embodiments related to a WTRU performing a determination of availability of NR SL overlapping resources for NR SL transmissions based on CBR and/or RSSI measurement are described herein. In an embodiment, a WTRU may determine not to apply the overlapping resources within a NR SL resource pool (i.e., disable the use of overlapping resources) for NR PSSCH/PSCCH transmissions for NR SL application(s) when one or more following conditions may be met. For example, the a WTRU may determine not to apply the overlapping resources within a NR SL resource pool on a condition that the number of NR SL resources in the NR SL overlapping resource set in the NR SL resource pool may be smaller than a (pre)configured threshold. In an example, the threshold may be indicated as a ratio of the total number of the NR SL overlapping resources to the total number of the resources within the NR SL resource pool.

For example, a WTRU may determine not to apply the overlapping resources within a NR SL resource pool on a condition that the priority of a NR SL application may be lower than a (pre)configured threshold (i.e. the value of the L1 priority of TB(s) of the NR SL application may be larger than a (pre)configured threshold).

For example, a WTRU may determine not to apply the overlapping resources within a NR SL resource pool on a condition that the CBR and/or RSSI and/or RSRP (based on LTE SL sensing) measurement of LTE SL resource pool(s) overlapping with the NR SL resource pool may be higher than a (pre)configured threshold.

For example, a WTRU may determine not to apply the overlapping resources within a NR SL resource pool on a condition that the CBR and/or RSSI measurement of the NR SL resource pool may be lower than a (pre)configured threshold.

For example, a WTRU may determine not to apply the overlapping resources within a NR SL resource pool on a condition that the CBR and/or RSSI measurement of LTE SL resource pool(s) overlapping with the NR SL resource pool may be higher than CBR and/or RSSI measurement of the NR SL resource pool.

For example, a WTRU may determine not to apply the overlapping resources within a NR SL resource pool on a condition that the CBR and/or RSSI measurement of LTE SL resource pool(s) overlapping with the NR SL resource pool may be higher than the sum of a CBR and/or RSSI measurement of the NR SL resource pool and a (pre)configured delta threshold value (i.e. CBR_{LTE_SL_resource_pool}>CBR_{NR_SL_Resource_Pool}+Delta_CBR_Th and/or RSSI_{LTE_SL_resource_pool}>RSSI_{NR_SL_Resource_Pool}+Delta_RSSI_Th).

For example, a WTRU may determine not to apply the overlapping resources within a NR SL resource pool on a condition that the CBR and/or RSSI measurement of the overlapping resources may be higher than a (pre)configured threshold.

For example, a WTRU may determine not to apply the overlapping resources within a NR SL resource pool on a condition that the CBR and/or RSSI measurement of the overlapping resources may be higher than the CBR and/or RSSI measurement of the non-overlapping resources.

For example, a WTRU may determine not to apply the overlapping resources within a NR SL resource pool on a condition that the CBR and/or RSSI measurement of the overlapping resources may be higher than the sum of CBR and/or RSSI measurement of the non-overlapping resources and a (pre)configured delta threshold value (i.e. CBR_{overlapping_resource}>CBR_{Non-overlapping_Resource}+Delta_CBR_Th and/or RSSI_{overlapping_resource}>RSSI_{Non-overlapping_Resource}+Delta_RSSI_Th).

When one or more of the example conditions are met, a WTRU may determine the LTE SL transmission activities in the overlapping resources in the NR SL resource pool may be high and may not use these resources for NR SL transmissions to avoid a potential collision with LTE SL transmissions. A WTRU may determine the NR SL transmission activities in the overlapping resources in the NR SL resource pool may be low and may allow the overlapping resources to use the overlapping resources exclusively.

In an embodiment, the (pre)configured thresholds applied in the above discussed conditions may be associated with the priority of the TBs of the NR SL application(s) intended for the PSSCH/PSCCH transmissions using the NR SL resource pool. In an example, a lower threshold may be applied when the priority is higher so given the same CBR and/or RSSI measurement, a WTRU may apply the overlapping resources for NR SL TBs of lower priority NR SL TBs but not higher priorities. This is to allow the WTRU to use these overlapping resources for low priority NR SL TB transmissions.

In an example, a WTRU may evaluate one or more above discussed measurement(s) and determine the availability of the overlapping resources within a NR SL resource pool for NR SL PSSCH/PSCCH transmissions for NR SL application(s) according to one or more of the following conditions. For example, a WTRU may perform such evaluation and determination periodically for a NR SL resource pool including overlapping resources. The periodicity may be (pre)configured. In an example, the periodicity may be associated with the QoS requirement(s) of NR SL application(s), (e.g., the priority of the TB(s) of the NR SL application(s)). A higher priority may be (pre)configured with a more frequent evaluation to avoid collisions with LTE SL transmission within the overlapping resources.

In an example, a WTRU may be triggered to perform such evaluation and determination for a NR SL resource pool including overlapping resources. The conditions for triggering may include: when a TB of the NR SL application(s) is to be transmitted; and/or when an additional LTE SL resource pool is configured and the resource pool includes LTE SL resources overlapping with the NR resource pool.

In an example, a WTRU may perform the evaluation according to the above discussed conditions and enable and disable the use of the NR SL overlapping resources for NR SL transmission for NR SL application(s). During an evaluation interval, when the overlapping resources are determined as unavailable, a WTRU may exclude the resources from resource selection when NR SL TBs are to be transmitted. These resources may be referred to as disabled overlapping resources in the NR SL resource pool. Also, during an evaluation interval, when the overlapping resources are determined as available, a WTRU may include the resources back into resource selection when NR SL TBs are to be transmitted. These resources may be referred to as enabled overlapping resources in the NR SL resource pool. In an example, a WTRU may request another NR resource pool when the overlapping resources in the NR SL resource pool indicated to use for NR SL transmission of a TB are disabled for the NR SL transmission as a result of the above discussed evaluation.

Embodiments for a WTRU to perform a determination of availability of NR SL overlapping resources for NR SL transmissions based on LTE SL sensing result are described herein. LTE SL sensing result may provide a WTRU with an estimate of LTE SL transmission activity at the overlapping resources, since the reserved LTE SL resources are excluded in the LTE sensing and the resulting Set A includes LTE SL resources considered to be available (i.e. having low activity). In an embodiment, a WTRU may determine not to apply the overlapping resources within a NR SL resource pool (i.e., disable the use of overlapping resources) for NR PSSCH/PSCCH transmissions for NR SL application(s) when one or more following conditions based on LTE SL sensing may be met: (1) the number of the overlapping resources included in the LTE SL sensing result (e.g. Set A) may be below a (pre)configured threshold; and (2) the number of the overlapping resources excluded in the LTE SL sensing result may be above a (pre)configured threshold.

Embodiments for a WTRU to perform a determination of availability of NR SL overlapping resources for NR SL transmissions based on LTE SL SCI decoding are described herein. In an embodiment, when a WTRU performs an evaluation of LTE SL activities in the overlapping resources in a NR SL resource pool in NR SL slot (n), a WTRU may derive the following information based on a LTE SCI decoding performed in a LTE SL resource pool within a (pre)configured period between NR SL slot (n) and slot (n−m) where m may be (pre)configured: (1) Number of reserved LTE SL transmissions within the overlapping resources; and or (2) average RSRP of PSCCHs including decoded SCIs within the overlapping resources.

In an example, a WTRU may determine not to apply the overlapping resources within a NR SL resource pool (i.e., disable the use of overlapping resources) for NR PSSCH/PSCCH transmissions for NR SL application(s) when one or more following conditions based on LTE SL sensing may be met: (1) the number of reserved LTE SL transmissions within the overlapping resources may exceed a (pre)configured threshold; and/or (2) the average RSRP of PSCCHs including decoded SCIs within the overlapping resources may be higher than a (pre)configure threshold.

Embodiments for WTRU determination of available NR SL single-slot resources with LTE SL resource exclusion are described herein.

A WTRU may be triggered to perform a resource (re)selection for PSSCH/PSCCH transmission(s) of a TB by a higher layer. A resource re-selection may include resource re-evaluation and pre-emption. A WTRU may be indicated (e.g. receive an indication) with the following information for the resource (re)selection: (1) the NR SL resource pool for the PSSCH/PSCCH transmission(s); (2) L1 priority of the NR SL TB (priorₜₓ); (3) the remaining packet delay budget (PDB); and (4) the number of sub-channels to be used for a PSSCH/PSCCH transmission in a NR SL slot (L_{subCH}).

A WTRU may determine to perform an LTE SL resource exclusion procedure when the indicated NR SL resource pool for the PSSCH/PSCCH transmission(s) may overlap with one or more (pre)configured LTE SL resource pools. A WTRU may determine the overlapping based on the mapping as described above (i.e., in embodiments for WTRU determination of overlapping mapping between NR SL and LTE SL resource pool).

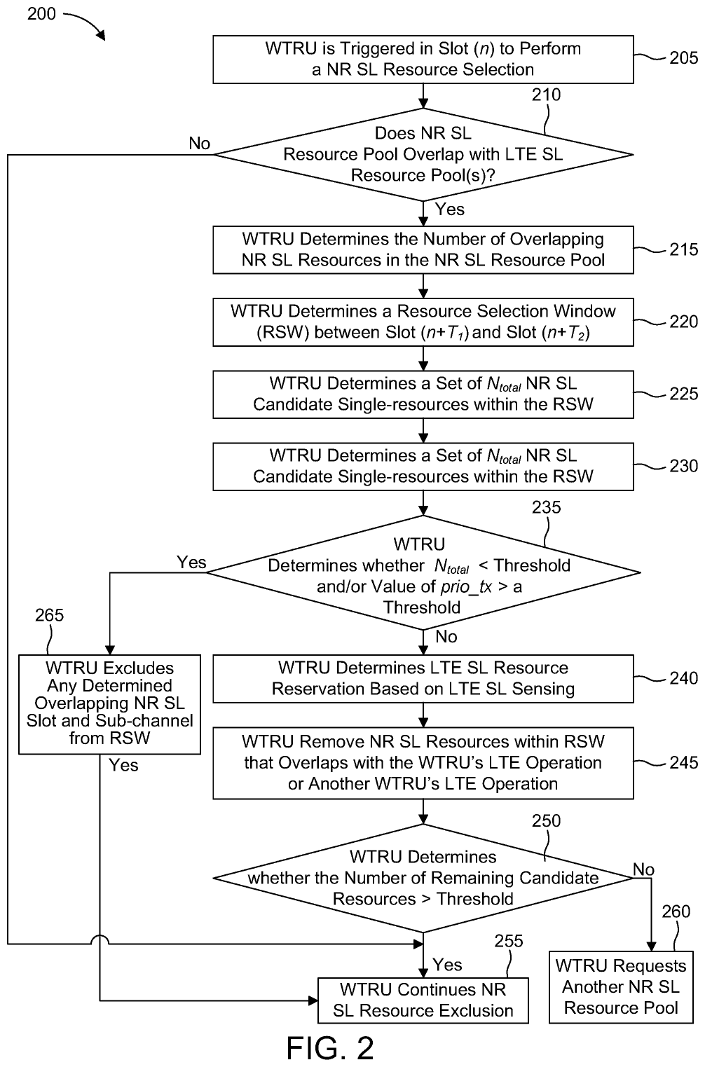

FIG. 2 is a diagram illustrating an example method of LTE side link (SL) resource exclusion in a NR SL resource (re)selection 200. A WTRU may perform an LTE SL resource exclusion procedure in NR SL slot (n). The WTRU may be triggered in a NR SL slot (i.e. slot (n) to perform NR SL resource selection 205. The NR SL resource selection may be for an indicated NR SL resource pool for transmission of a TB with an L1 priority (prior_tx). The WTRU may determine whether the NR SL resource pool overlaps with one or more LTE SL resource pools 210. On a condition that the NR SL resource pool does not overlap with one or more LTE SL resource pools, the WTRU may proceed to a NR SL resource exclusion procedure 255. On a condition that the NR SL resource pool does overlap with one or more LTE SL resource pools, the WTRU may determine the number of overlapping NR SL resources in the NR SL resource pool 215.

The WTRU may determine a NR SL resource selection window (RSW) including a time interval between NR SL slot (n+T₁) and slot (n+T₂) of the NR SL resource pool 220. The WTRU may determine the value of T₁ based on, for example, WTRU processing capability of performing NR sensing in the indicated NR SL resource pool and LTE SL sensing in the determined overlapping LTE SL resource pool(s). The WTRU may determine the value of T₂ based on, for example, an indicated remaining Packet Delay Budget (PDB).

The WTRU may determine a candidate NR SL single-slot resource as a NR SL resource over any consecutive L_{subCH} sub-channels in a NR single slot in the indicated NR SL resource pool. The WTRU may determine a candidate resource set of such candidate NR SL single-slot resource(s) over any L_{subCH} sub-channels in each NR SL slot within the determined RSW. The WTRU may determine the total number of candidate NR SL single-slot resources in the candidate resource set as Nₜₒₜₐₗ 225.

The WTRU may determine a NR PSFCH resource corresponding to each candidate NR SL single-slot resource in the candidate resource set Nₜₒₜₐₗ 230. When a TX WTRU may transmit a HARQ enabled PSSCH/PSCCH transmission in a NR SL single-slot resource, a RX WTRU may transmit a corresponding PSFCH carrying the HARQ feedback information in a PSFCH resource determined based on the PSSCH/PSCCH sub-channels and (pre)configured PSFCH occasions and RB allocation in the resource pool. Thus, when a WTRU may reserve a NR SL single-slot resource for a HARQ-enabled PSSCH/PSCCH transmission, a corresponding PSFCH resource may be reserved.

The WTRU may determine whether the number of NR SL single-slot resource candidates in Nₜₒₜₐₗ is less than a threshold or a value of prio_tx is greater than a threshold 235. Alternatively, the WTRU may determine whether the number of NR SL single-slot resource candidates in Nₜₒₜₐₗ is less than a threshold and a value of prio_tx is greater than a threshold. On a condition that the determination is true, the WTRU may exclude any determined overlapping NR SL slot and sub-channel from the RSW 265. On a condition that the determination is false the WTRU may perform LTE SL sensing in the overlapping LTE SL resource pool(s) and determine LTE SL resource reservation information applicable to the NR SL RSW 240. The LTE SL resource reservation information may include, but are not limited to: (1) the (pre)configured LTE PSSS/SSSS resources (LTE SL subframe and sub-channel index); (2) LTE SL single-subframe resource(s) reserved for a LTE SL transmission by the WTRU; (3) LTE SL single-subframe resource(s) reserved for a LTE SL transmission to be received by the WTRU (i.e., the WTRU destination ID indicated in the SCI of the LTE SL transmission may be (pre)configured for the WTRU); and (4) LTE SL single-subframe resource(s) reserved for LTE SL transmissions by other WTRUs and L1 priorities (prior_{LTE_tx}) and RSRP associated with the resource(s).

The WTRU may exclude any candidate NR SL single-slot resource from the candidate NR SL single-slot resource set within the RSW 245 based on one or more of the following conditions.

The WTRU may exclude a candidate NR SL single-slot resource from the candidate NR SL single-slot resource set on a condition that the candidate NR SL single-slot resource may overlap with the (pre)configured LTE SL PSSS/SSSS resource and the WTRU may be (pre)configured or determine to perform LTE SL PSSS/SSS transmission, (i.e. a potential in-device conflict between NR PSSCH/PSCCH transmission and the WTRU's LTE SL PSSS/SSSS transmission may exist).

The WTRU may exclude a candidate NR SL single-slot resource from the candidate NR SL single-slot resource set on a condition that the candidate NR SL single-slot resource of which the corresponding PSFCH resource may overlap with the (pre)configured LTE SL PSSS/SSSS resource and the WTRU may be (pre)configured or determine to perform LTE SL PSSS/SSS transmission, (i.e. a potential in-device conflict between NR PSFCH reception and the WTRU's LTE SL PSSS/SSSS transmission may exist.

The WTRU may exclude a candidate NR SL single-slot resource from the candidate NR SL single-slot resource set on a condition that the candidate NR SL single-slot resource may overlap with the (pre)configured LTE SL PSSS/SSSS resource and the WTRU may be (pre)configured or determine to synchronize with LTE SL PSSS/SSSS transmission (e.g., for an out-of-coverage WTRU), (i.e., a potential in-device conflict between NR PSSCH/PSCCH transmission and the WTRU's LTE SL PSSS/SSSS reception may exist).

The WTRU may exclude a candidate NR SL single-slot resource from the candidate NR SL single-slot resource set on a condition that the candidate NR SL single-slot resource of which the corresponding PSFCH resource may overlap with the (pre)configured LTE SL PSSS/SSSS resource and the WTRU may be (pre)configured or determine to synchronize with LTE SL PSSS/SSSS transmission (e.g., for an out-of-coverage WTRU), (i.e., a potential in-device conflict between NR PSFCH reception and the WTRU's LTE SL PSSS/SSSS reception may exist).

The WTRU may exclude a candidate NR SL single-slot resource from the candidate NR SL single-slot resource set on a condition that the candidate NR SL single-slot resource may overlap with an LTE SL single-frame resource reserved for the WTRU's LTE SL transmission, (i.e. a potential in-device conflict between NR PSSCH/PSCCH transmission and the WTRU's LTE SL PSSCH transmission may exist.

The WTRU may exclude a candidate NR SL single-slot resource from the candidate NR SL single-slot resource set on a condition that the candidate NR SL single-slot resource of which the corresponding PSFCH resource may overlap with an LTE SL single-frame resource reserved for the WTRU's LTE SL transmission, (i.e. a potential in-device conflict between NR PSFCH reception and the WTRU's LTE SL PSSCH transmission may exist).

The WTRU may exclude a candidate NR SL single-slot resource from the candidate NR SL single-slot resource set on a condition that the candidate NR SL single-slot resource may overlap with an LTE SL single-frame resource reserved for the WTRU's LTE SL reception, (i.e. a potential in-device conflict between NR PSSCH/PSCCH transmission and the WTRU's LTE SL PSSCH reception may exist).

The WTRU may exclude a candidate NR SL single-slot resource from the candidate NR SL single-slot resource set on a condition that the candidate NR SL single-slot resource of which the corresponding PSFCH resource may overlap with an LTE SL single-frame resource reserved for the WTRU's LTE SL reception, (i.e. a potential in-device conflict between NR PSFCH reception and the WTRU's LTE SL PSSCH reception may exist).

The WTRU may exclude a candidate NR SL single-slot resource from the candidate NR SL single-slot resource set on a condition that the candidate NR SL single-slot resource may overlap with the (pre)configured LTE SL PSSS/SSSS resource and the WTRU may not perform PSSS/SSSS transmission or reception, (i.e. a potential collision between NR PSSCH/PSCCH transmission and another WTRU's LTE PSSS/SSSS transmission may exist).

The WTRU may exclude a candidate NR SL single-slot resource from the candidate NR SL single-slot resource set on a condition that the candidate NR SL single-slot resource of which the corresponding PSFCH resource may overlap with the (pre)configured LTE SL PSSS/SSSS resource and the WTRU may not perform PSSS/SSSS transmission or reception, (i.e. a potential collision between NR PSFCH transmission and another WTRU's LTE PSSS/SSSS transmission may exist).

The WTRU may exclude a candidate NR SL single-slot resource from the candidate NR SL single-slot resource set on a condition that the candidate NR SL single-slot resource may overlap with an LTE SL single-frame resource reserved for another WTRU's LTE SL PSSCH transmission, (i.e. a potential collision between NR PSSCH/PSCCH transmission and another WTRU's LTE SL PSSCH transmission may exist).

The WTRU may exclude a candidate NR SL single-slot resource from the candidate NR SL single-slot resource set on a condition that the candidate NR SL single-slot resource of which the corresponding PSFCH resource may overlap with an LTE SL single-frame resource reserved for another WTRU's LTE SL PSSCH transmission, (i.e. a potential collision between NR PSFCH reception and another WTRU's LTE SL PSSCH transmission may exist).

The WTRU may determine to exclude a candidate NR SL single-slot resource from the candidate NR SL single-slot resource set based on L1 priority of the NR SL TB (priorₜₓ), L1 priorities (prior_{LTE_tx}) of the overlapping LTE SL single subframe resource and/or RSRP associated with the overlapping LTE SL resource. In an example, a WTRU may exclude such a NR SL candidate resource from the set when one or more of the following conditions(s) may be met: (i) when the value of the overlapping LTE SL resource (prior_{LTE_tx}) may be less than a (pre)configured threshold; (ii) when the RSRP associated with the overlapping LTE SL resource may be higher than a (pre)configured RSRP threshold, which may be determined based on priorₜₓ) and/or prior_{LTE_tx}, and/or (iii) when the value of L1 priority of the NR SL TB (priorₜₓ) may be larger or greater than the value of L1 priority associated with the overlapping LTE SL resource (prior_{LTE_tx}).

The WTRU may determine whether the number of remaining candidate NR SL single-slot resources are greater than or equal to a threshold or determined or calculated value 250. The determined or calculated value may be a percentage (P %) of Nₜₒₜₐₗ. P may be (pre)configured and associated with L1 priority of the NR SL TB (priorₜₓ). On a condition that the number of candidate NR SL single-slot resources remaining in the candidate resource set is less than (not greater than or equal to) the threshold or determined or calculated value (e.g. P % of Nₜₒₜₐₗ) the WTRU may stop NR SL resource selection and request another NR SL resource pool (e.g. from a higher layer) for transmission of the NR SL TB 260. The LTE SL resource pools overlapping with the indicated NR SL resource pool may be congested.

On a condition that the number of candidate NR SL single-slot resources remaining in the candidate resource set is greater than or equal to the threshold or determined or calculated value (e.g. P % of Nₜₒₜₐₗ), the WTRU may continue to perform a NR SL resource exclusion procedure within the indicated NR SL resource pool 255.

The WTRU may determine the overlapping (with regard to block 245) between a NR SL single-slot resource and LTE SL single-subframe resource based on a mapping as described above (i.e., embodiments for WTRU determination of overlapping mapping between a NR SL and LTE SL resource pool).

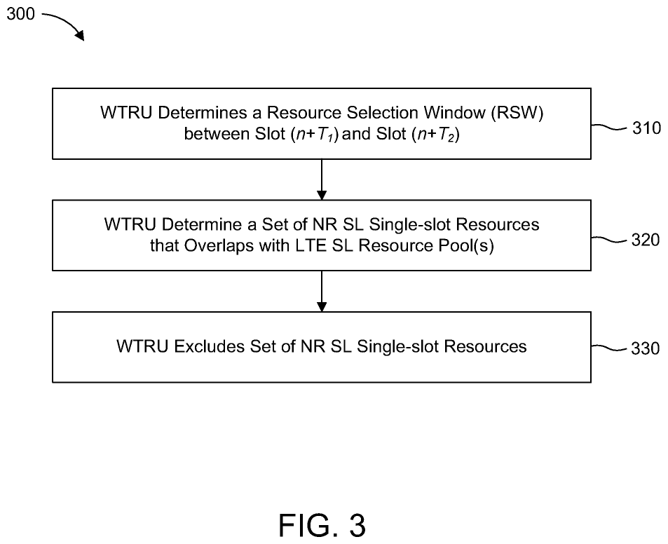

In an embodiment, a WTRU may perform a pre-emptive LTE SL resource exclusion procedure 300 in NR SL slot (n) as shown in FIG. 3.

A WTRU may determine a NR SL resource selection window (RSW) including a time interval between NR SL slot (n+T₁) and slot (n+T₂) of a NR SL resource pool 310. The WTRU may determine the value of T₁ based on, for example, WTRU processing capability of performing NR sensing in an indicated NR SL resource pool and LTE SL sensing in a determined overlapping LTE SL resource pools. The WTRU may determine the value of T₂ based on, for example, an indicated remaining PDB.

The WTRU may determine a set of NR SL single-slot resource within the determined RSW that may overlap with one or more LTE SL resource pools 320. The WTRU may determine such an overlapping based on a mapping as described above (i.e., embodiments for WTRU determination of overlapping mapping between NR SL and LTE SL resource pool).

The WTRU may exclude the set of NR SL single-slot resources from the RSW 330. The exclusion may be based on one or more of the following conditions: (1) the number of the determined NR SL single-slot resources within the RSW is smaller than a (pre)configured p % of Nₜₒₜₐₗ. (2) the value of L1 priority of the NR SL TB (priorₜₓ) is larger than a (pre)configured threshold, and/or (3) the overlapping resources may be determined as unavailable (i.e., disabled) based on the WTRU's determination of availability of an overlapping resource set within a NR SL resource pool for NR SL PSSCH/PSCCH transmissions for a NR SL application as discussed above. For example, the WTRU may determine whether an overlapping resource set within a NR SL resource pool may be available for NR SL PSSCH/PSCCH transmissions for NR SL application(s) based on one or more of the following: the number of NR SL resources in the overlapping resource set in the NR SL resource pool; QoS requirement(s) of the NR SL application(s) (e.g., priority of the SL TBs associated with the NR SL application(s)); CBR and/or RSSI measurement of the NR SL resource pool; CBR and/or RSSI measurement of LTE SL resource pool(s) overlapping with the NR SL resource pool; CBR and/or RSSI measurement of the overlapping resources within the NR SL resource pool; CBR and/or RSSI measurement of the non-overlapping resources within the NR SL resource pool; LTE SL sensing result of the overlapping LTE SL resource pool(s); and/or LTE SCI decoding information.

When the conditions for excluding the set of NR SL single-slot resources is not met, the WTRU may perform an LTE SL resource exclusion procedure, for example as shown in FIG. 2, including LTE SL sensing information.

The WTRU may determine to continue with a NR SL resource selection procedure within the indicated NR SL resource pool.

In such a pre-emptive LTE SL resource exclusion, a WTRU may exclude any NR SL resources that may cause in-device conflict and/or collision with LTE SL operation from the NR SL resource (re)selection without considering whether or not the overlapping resource(s) may be actually reserved for upcoming LTE SL operation. This may reduce a LTE SL sensing process for the exclusion procedure and provide protection of LTE SL service (e.g. public safety) at an expense of inefficient utilization of the NR SL resources. A (pre)configured overlapping resource ratio (p) and L1 priority threshold may provide a trade-off so that the pre-emption may apply to low priority NR SL TBs in a scenario where the number of overlapping resources may be small relative to total number of resources of the resource pool.

Embodiments for NR Mode 2 Inter-WTRU coordination for conflict with LTE V2X resource reservation are described herein.

A transmitter (TX) WTRU may perform an LTE SL resource exclusion in a NR SL resource (re)selection as described herein to enable co-channel in-device existence at the TX WTRU and collision avoidance based on the TX WTRU's LTE sensing information. While LTE PSSS/SSSS (pre)configuration may be identical for a TX WTRU and receiver (RX) WTRU, a TX WTRU may not be aware of LTE SL traffic and data operation by a RX WTRU. As a result, the reserved NR SL resources may cause in-device conflict with LTE SL operation at the RX WTRU. In addition, due to a hidden node issue, a TX WTRU's LTE SL sensing may not capture the resource reservation by WTRU(s) close to the RX WTRU and thus lead to an overlapping between the NR SL resource reserved by the TX WTRU and LTE SL resource reservation by another WTRU.

A NR SL WTRU may not be equipped by both LTE SL and NR SL radio access HW capabilities and may not determine the availability of the overlapping resources (e.g. due to LTE SL resource reservations) as discussed herein. In this case, a NR SL WTRU equipped with NR SL HW may rely on information, (e.g., inter-WTRU coordination information), received from another NR SL WTRU with both NR SL and LTE SL HW, to avoid reserving a NR SL resource that may be unavailable due to LTE SL transmissions within the overlapping resources.

A RX WTRU may receive a NR SL resource reservation in a SCI in a PSSCH/PSCCH transmission in a slot (n). A RX WTRU may determine that the resource pool used for the reserved PSSCH/PSCCH transmission resources may overlap with one or more LTE resource pools. A RX WTRU may perform a conflict detection for the reserved resource(s) based on one or more of the following information: (1) the (pre)configured LTE PSSS/SSSS resources (LTE SL subframe and sub-channel index); (2) LTE SL single-subframe resource(s) reserved for a LTE SL transmission by the RX WTRU; (3) LTE SL single-subframe resource(s) reserved for a LTE SL transmission to be received by the RX WTRU, (i.e., the WTRU destination ID indicated in the SCI of the LTE SL transmission may be (pre)configured for the RX WTRU); and/or (4) LTE SL single-subframe resource(s) reserved for LTE SL transmissions by other WTRUs and L1 priorities (prior_{LTE_tx}) and RSRP associated with the resource(s).

A RX WTRU may detect a conflict between a reserved NR SL resource and an in-device LTE SL operation by the RX WTRU when at least one or more of the following conditions occurs.

A condition for detecting a conflict may be that the reserved NR SL single-slot resource may overlap with the (pre)configured LTE SL PSSS/SSSS resource and the RX WTRU may be (pre)configured or determine to perform LTE SL PSSS/SSS transmission, (i.e. a potential in-device conflict between NR PSSCH/PSCCH reception and the WTRU's LTE SL PSSS/SSSS transmission).

A condition for detecting a conflict may be that the reserved NR SL single-slot resource of which the corresponding PSFCH resource may overlap with the (pre)configured LTE SL PSSS/SSSS resource and the WTRU may be (pre)configured or determine to perform LTE SL PSSS/SSS transmission, (i.e. a potential in-device conflict between NR PSFCH transmission and the WTRU's LTE SL PSSS/SSSS transmission).

A condition for detecting a conflict may be that the reserved NR SL single-slot resource may overlap with the (pre)configured LTE SL PSSS/SSSS resource and the WTRU may be (pre)configured or determine to synchronize with LTE SL PSSS/SSSS transmission (e.g., for an out-of-coverage WTRU), (i.e., a potential in-device conflict between NR PSSCH/PSCCH reception and the WTRU's LTE SL PSSS/SSSS reception).

A condition for detecting a conflict may be that the reserved NR SL single-slot resource of which the corresponding PSFCH resource may overlap with the (pre)configured LTE SL PSSS/SSSS resource and the WTRU may be (pre)configured or determine to synchronize with LTE SL PSSS/SSSS transmission (e.g., for an out-of-coverage WTRU), (i.e., a potential in-device conflict between NR PSFCH transmission and the WTRU's LTE SL PSSS/SSSS reception).

A condition for detecting a conflict may be that the reserved NR SL single-slot resource may overlap with an LTE SL single-frame resource reserved for the WTRU's LTE SL transmission, (i.e. a potential in-device conflict between NR PSSCH/PSCCH reception and the WTRU's LTE SL PSSCH transmission).

A condition for detecting a conflict may be that the reserved NR SL single-slot resource of which the corresponding PSFCH resource may overlap with an LTE SL single-frame resource reserved for the WTRU's LTE SL transmission, (i.e. a potential in-device conflict between NR PSFCH transmission and the WTRU's LTE SL PSSCH transmission).

A condition for detecting a conflict may be that the reserved NR SL single-slot resource may overlap with an LTE SL single-frame resource reserved for the WTRU's LTE SL reception, (i.e. a potential in-device conflict between NR PSSCH/PSCCH reception and the WTRU's LTE SL PSSCH reception).

A condition for detecting a conflict may be that the reserved NR SL single-slot resource of which the corresponding PSFCH resource may overlap with an LTE SL single-frame resource reserved for the WTRU's LTE SL reception, (i.e. a potential in-device conflict between NR PSFCH transmission and the WTRU's LTE SL PSSCH reception).

A RX WTRU may detect a conflict between a reserved NR SL resource and a LTE SL resource reserved by another WTRU when one or more of the following conditions occurs: (1) the reserved NR SL single-slot resource may overlap with a LTE SL single-frame resource reserved for another WTRU's LTE SL PSSCH transmission, (i.e. a potential collision between NR PSSCH/PSCCH reception and another WTRU's LTE SL PSSCH transmission); and (2) the candidate NR SL single-slot resource of which the corresponding PSFCH resource may overlap with a LTE SL single-frame resource reserved for another WTRU's LTE SL PSSCH transmission, (i.e. a potential collision between NR PSFCH transmission and another WTRU's LTE SL PSSCH transmission).

In an embodiment, when the overlapping between a reserved NR SL resource and an LTE SL resource reserved by another WTRU is detected, a WTRU may detect a conflict based on L1 priority of the NR SL TB (priorₜₓ), L1 priorities (prior_{LTE_tx}) of the overlapping LTE SL single subframe resource and/or RSRP associated with the overlapping LTE SL resource. In an example, a WTRU may detect a conflict when one or more of the following conditions(s) is met.

A condition for detecting a conflict may be if the value of the overlapping LTE SL resource (prior_{LTE_tx}) is less than a (pre)configured threshold.

A condition for detecting a conflict may be if the RSRP associated with the overlapping LTE SL resource is higher than a (pre)configured RSRP threshold, which may be determined based on prior and/or prior_{LTE_tx}.

A condition for detecting a conflict may be if the value of L1 priority of the NR SL TB (priorₜₓ) is larger than the value of L1 priority associated with the overlapping LTE SL resource (prior_{LTE_tx}).

Upon a detection of a conflict, a RX WTRU may perform a PSFCH transmission to indicate the reserved resource may be in conflict to the NR SL TX WTRU. In an embodiment, a RX WTRU may transmit a sequence (pre)configured for a NR SL resource reservation in conflict. In an example, a ZC sequence with a cyclic shift (m_cs) equal to zero may be applied. In an example, a RX WTRU may be (pre)configured with a sequence dedicated to indicating a conflict between a NR SL resource reservation and LTE SL operation. Such a ZC sequence may be (pre)configured with a cyclic shift (m_cs) equal to, for example, six.

In an embodiment, a RX WTRU may be (pre)configured with a set of sequences with different cyclic shifts dedicated for indication of a conflict with LTE SL operation. Each cyclic shift value may further indicate the location in time domain of the reserved single-slot NR SL resource within the overlapping single-subframe LTE SL resource. Due to the difference in SCS of a NR and LTE SL resource pool, a single-subframe LTE SL resource may span over one or more consecutive single-slot NR SL resources. In an example, when LTE SL and NR SL SCS is 15 KHz and 30 kHz, respectively, a RX WTRU may transmit a PSFCH sequence to indicate the reserved NR SL single-slot resource may partially overlap with the first or the second part of a single-subframe LTE SL resource. When the PSFCH may indicate an overlapping between the reserved NR SL single-slot resource with the first part of a LTE SL single-subframe resource, a TX WTRU may determine the NR slot after (e.g. immediately after) the one including the reserved single-slot NR SL resource may be in conflict with LTE SL operation. When the PSFCH may indicate an overlapping between the reserved NR SL single-slot resource with the second part of a LTE SL single-subframe resource, a TX WTRU may determine the NR slot before (e.g. immediately before) the one including the reserved single-slot NR SL resource may be in conflict with LTE SL operation.

A TX WTRU, upon receiving a PSFCH sequence, may perform a resource re-selection for the transmission scheduled at the indicated resource in conflict. When the received PSFCH sequence indicates a conflict with a LTE SL operation, the TX WTRU may perform an exclusion of the NR slot including the reserved NR SL single-slot resource from the resource re-selection. In an embodiment, when the received PSFCH sequence further indicates the location in time domain of the reserved single-slot NR SL resource within the overlapping single-subframe LTE SL resource, the TX WTRU may determine which NR slot(s) in addition to the NR slot including the reserved NR SL single-slot resource may overlap with a single-subframe LTE SL resource based on the indication. The TX WTRU may perform an exclusion of all such NR slots from the resource re-selection.

Embodiments for WTRU transmission of NR SL overlapping resource information based on inter-WTRU coordination are described herein. In an embodiment, a WTRU may indicate the overlapping resources in a non-preferred resource set and perform a transmission of the non-preferred resource set in a SCI and/or MAC CE. A WTRU may indicate in the SCI that the resources may be non-preferred due to LTE SL transmission activity. A WTRU may be triggered to perform such a transmission under one or more of the following conditions.

A condition may be that the WTRU may determine that an overlapping resource set within a NR SL resource pool may be unavailable for NR SL transmissions as discussed regarding WTRU determination of availability of an overlapping resource set within a NR SL resource pool for NR SL PSSCH/PSCCH transmissions for a NR SL application.

A condition may be that the WTRU may receive a request to provide non-preferred resources specific to overlapping resources between NR and LTE SL resource pools. In an example, the request may include an indication (e.g., in a SCI) to indicate the type of requested the non-preferred resource set may be the unavailable overlapping NR SL resources in a NR SL resource pool. Such a request may include a SCI indication of the NR SL resource pool.

When a WTRU receives such a non-preferred resource set, the WTRU may determine that the received resources may be unavailable (i.e., disabled) in the NR SL resource pool. The WTRU may not include these resources in resource selections for NR SL transmissions using the resource pool.

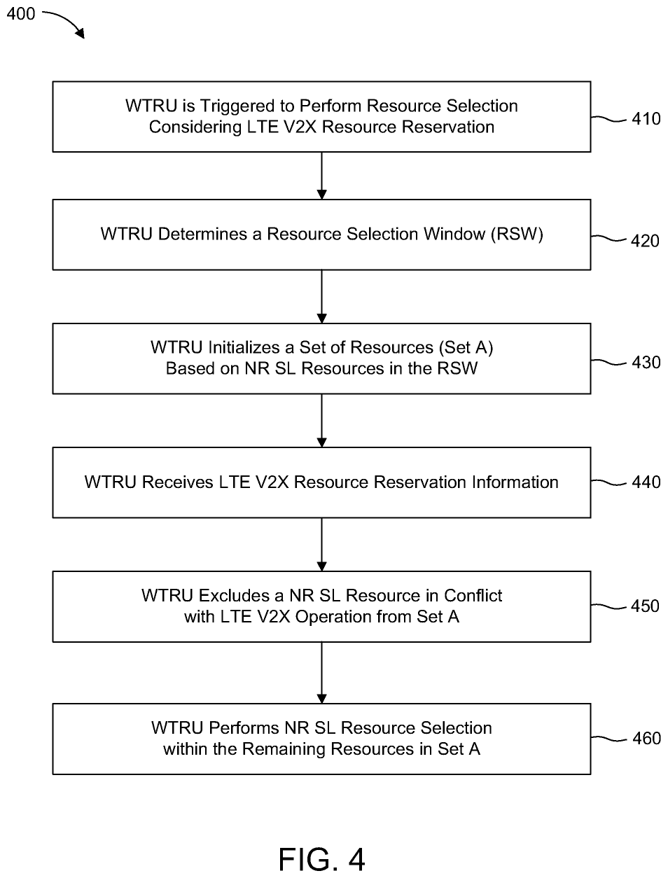

FIG. 4 shows an example method for an NR V2X WTRU performing resource selection considering LTE V2X resource reservation 400. A WTRU may be triggered to perform NR SL resource (re)selection in a NR SL resource pool 410. The WTRU may be triggered via an indication. The indication may be V2X transmission information received from a higher layer (e.g. V2X layer). The WTRU may determine a resource selection window (RSW). The RSW make be determined based on predetermined times such as T₁ and T₂ 420. The RSW may comprise a time interval between NR SL slot (n+T₁) and slot (n+T₂) of the NR SL resource pool. The WRU may determine the value of T₁ based on for example, WTRU processing capability of performing NR sensing in the indicated NR SL resource pool and LTE SL sensing in the determined overlapping LTE SL resource pools. The WTRU may determine the value of T₂ based on, for example, an indicated remaining PDB. The WTRU may initialize a set of resources (e.g. Set A) based on the NR SL resources in the RSW 430.

The WTRU may receive LTE V2X resource reservation information 440. For example, the WTRU may receive the LTE V2X resource reservation information based on LTE V2X sensing. The LTE V2X resource reservation information may include, but are not limited to: LTE SSB resource configuration; received LTE SSB RSRP; resources reserved for an LTE V2X transmission by the WTRU; resources reserved for an LTE V2X transmission intended for the WTRU; and resources reserved for an LTE V2X transmission not intended for the WTRU and RSRP associated with the resource.

The WTRU may exclude a NR SL resource in conflict with LTE V2X operation from Set A 450. The WTRU may exclude a NR SL resource in conflict with the LTE V2X operation from Set A when the resource or the PSFCH resource corresponding to the resource (e.g., based on the PSFCH resource configuration in the NR SL resource pool) overlaps with a LTE SSB resource, resources reserved for an LTE V2X transmission by the WTRU or the resources reserved for an LTE V2X transmission intended for the WTRU. The WTRU may exclude a NR SL resource in conflict with LTE V2X operation from Set A when the resource or the PSFCH resource corresponding to the resource (e.g. based on the PSFCH resource configuration in the NR SL resource pool) overlaps with resources reserved for LTE SSB resources and the associated SSB RSRP is larger than a threshold and/or overlaps with resources reserved for an LTE V2X transmission not intended for the WTRU and the associated RSRP is larger than a threshold.

The WTRU may perform NR SL resource selection within the remaining resources in Set A 460.

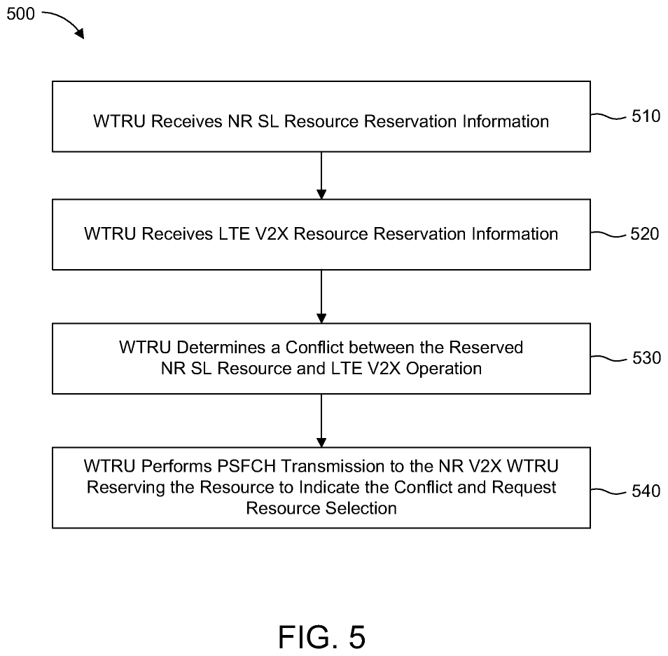

FIG. 5 shows an example method for an NR V2X WTRU performing detection of conflict between LTE and NR V2X transmission 500. A WTRU may receive a NR SL resource reservation (or NR SL resource reservation information) 510. The WTRU may receive LTE V2X resource reservation information 520. The LTE V2X resource reservation information may be based on LTE V2X sensing. The LTE V2X resource reservation information may include, but are not limited to: LTE SSB resource configuration; received LTE SSB RSRP; resources reserved for an LTE V2X transmission by the WTRU; resources reserved for an LTE V2X transmission intended for the WTRU; and resources reserved for an LTE V2X transmission not intended for the WTRU and RSRP associated with the resource.

The WTRU may determine a conflict between the reserved NR SL resource and LTE V2X operation 530. The WTRU may determine a conflict between the reserved NR SL resource and LTE V2X operation on a condition that the resource or the PSFCH resource corresponding to the resource (based on the PSFCH resource configuration in the NR SL resource pool) overlaps with LTE SSB resources, resources reserved for an LTE V2X transmission by the WTRU, or the resources reserved for an LTE V2X transmission intended for the WTRU. The WTRU may determine a conflict between the reserved NR SL resource and LTE V2X operation on a condition that the resource or the PSFCH resource corresponding to the resource (based on the PSFCH resource configuration in the NR SL resource pool) overlaps with resources reserved for LTE SSB resources and the associated SSB RSRP is larger than a threshold and/or overlaps with resources reserved for an LTE V2X transmission not intended for the WTRU and the associated RSRP is larger than a threshold.

The WTRU may perform a PSFCH transmission to the NR V2X WTRU reserving the resource to indicate the conflict and request a resource (re)selection 540.

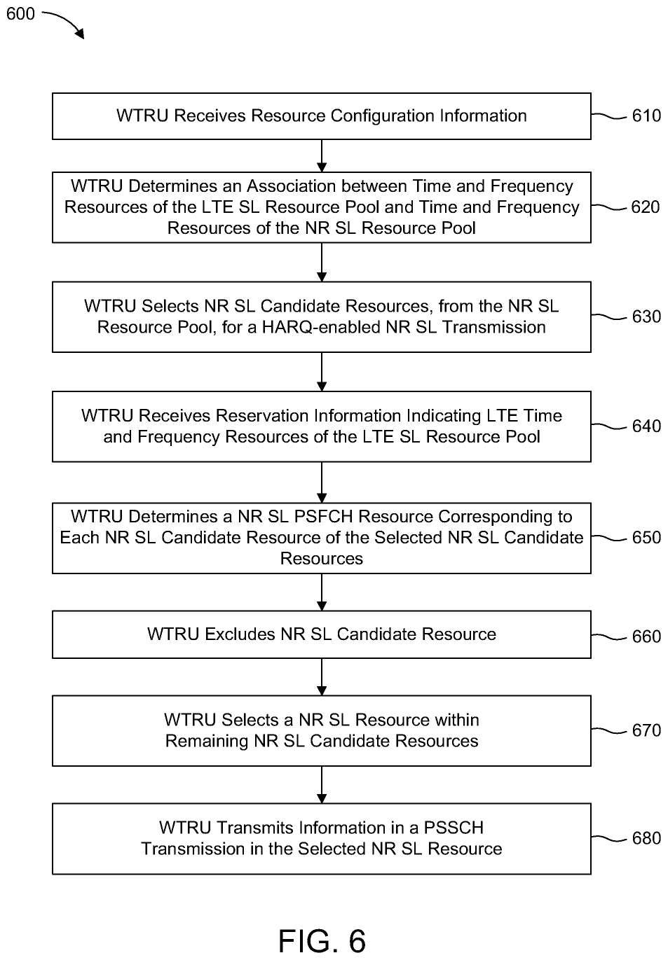

FIG. 6 shows an example method for performing NR SL resource selection 600. A WTRU may receive resource configuration information 610. The resource configuration information may comprise information regarding a Long Term Evolution (LTE) sidelink (SL) resource pool and a New Radio (NR) SL resource pool. The resource configuration information may comprises LTE SL sub-carrier spacing information, NR SL sub-carrier spacing information, a number of physical resource blocks (PRBs) for an LTE SL sub-channel, a number of PRBs for a NR SL sub-channel, LTE SL synchronization signal (SSS) resource configuration information, and NR physical SL feedback channel (PSFCH) resource configuration information. The WTRU may determine an association between time and frequency resources of the LTE SL resource pool and time and frequency resources of the NR SL resource pool 620. The association between time and frequency resources of the LTE SL resource pool and time and frequency resources of the NR SL resource pool may be based on the received resource configuration information. The association may comprise an association between an LTE SL subframe and one or more NR SL slots, and an association between an LTE SL sub-channel and one or more NR SL sub-channels. The association may comprise a logical index of an LTE SL sub-frame to one or more indices of one or more NR SL slots, and an index of an LTE SL sub-channel to one or more NR SL sub-channels. The WTRU may select NR SL candidate resources, from the NR SL resource pool, for a hybrid automatic repeat request (HARQ)-enabled NR SL transmission 630. The WTRU may select a NR SL candidate resource in response to received trigger information. The WTRU may select the NR SL candidate resources within a resource selection window (RSW). The WTRU may receive reservation information indicating LTE time and frequency resources of the LTE SL resource pool 640. The reservation information indicating LTE time and frequency resources may be based on LTE sensing. The LTE sensing may be LTE V2X sensing. The information indicating LTE time and frequency resources may comprise LTE SL synchronized signal block (SSB) resources, received LTE SSB reference signal receive power (RSRP), resources reserved for an LTE V2X transmission by the WTRU, resources reserved for an LTE V2X transmission intended for the WTRU, resources reserved for an LTE V2X transmission not intended for the WTRU, and RSRPs for the resources reserved for the LTE V2X transmission not intended for the WTRU. The WTRU may determine a NR SL physical SL feedback channel (PSFCH) resource corresponding to each NR SL candidate resource of the selected NR SL candidate resources 650. a NR SL PSFCH resource corresponding to each NR SL candidate resource may be determined based on the NR PSFCH resource configuration information. The WTRU may exclude a NR SL candidate resource from the selected NR SL candidate resources 660. The WTRU may exclude more than one NR SL candidate resource. Time and frequency resources of the excluded NR SL candidate resource may overlap with the indicated LTE time and frequency resources or time and frequency resources of the determined NR SL PSFCH resource may overlap with the indicated LTE time and frequency resources. Time and frequency resources of the excluded NR SL candidate resource may overlap with time and frequency resources of an LTE SL synchronization signal (SSS). Time and frequency resources of the excluded NR SL resource may overlap with an LTE SSB resource, the resources reserved for the LTE V2X transmission by the WTRU, or the resources reserved for an LTE V2X transmission intended for the WTRU. The WTRU may exclude a NR SL candidate resource based on the determined association between time and frequency resources of the LTE SL resource pool and time and frequency resources of the NR SL resource pool. The excluded NR SL candidate resources may be based on a priority of a NR SL transport block or a priority of the indicated LTE time and frequency resources. For example, a NR SL candidate resource may be excluded on a condition that a priority value (e.g. L1 priority) of an overlapping LTE SL resource (prior_{LTE_tx}) is less than a threshold value. For example, a NR SL candidate resource may be excluded on a condition that a value of a priority (e.g. L1 priority) of a NR SL transport block (priorₜₓ) is larger than a value of an overlapping LTE SL resource. For example, a NR SL candidate resource may be excluded on a condition that an RSRP associated with an overlapping LTE SL resource is larger than a RSRP threshold, which may be determined based on prior and/or prior_{LTE_tx}. The WTRU may select a NR SL resource within remaining NR SL candidate resources 670. The selected NR SL resource may be time and frequency resources. The WTRU may transmit information in a NR SL physical sidelink shared channel (PSSCH) transmission in the selected NR SL resource 680.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a wireless transmit/receive unit (WTRU), the method comprising:
receiving configuration information indicating reference signal received power (RSRP) threshold information;
selecting New Radio (NR) sidelink (SL) candidate resources, from a NR SL resource pool, for a hybrid automatic repeat request (HARQ)-enabled NR SL transmission, based on Long Term Evolution (LTE) sensing information, wherein the LTE sensing information indicates reserved LTE SL resources of another WTRU;
determining a NR SL physical SL feedback channel (PSFCH) resource associated with each NR SL candidate resource of the selected NR SL candidate resources;
excluding a NR SL candidate resource from the selected NR SL candidate resources, wherein the excluded NR SL candidate resource has an associated NR SL PSFCH resource that overlaps with at least one of the reserved LTE SL resources of the another WTRU;
selecting a NR SL resource within remaining NR SL candidate resources; and
transmitting information in a NR SL physical sidelink shared channel (PSSCH) transmission in the selected NR SL resource.

2. The method of claim 1, wherein the received configuration information comprises at least one of: LTE SL sub-carrier spacing information, NR SL sub-carrier spacing information, a number of physical resource blocks (PRBs) for an LTE SL sub-channel, a number of PRBs for a NR SL sub-channel, LTE SL synchronization signal (SSS) resource configuration information, and NR SL PSFCH resource configuration information.

3. The method of claim 1, further comprising determining an association between time and frequency resources of an LTE SL resource pool and time and frequency resources of the NR SL resource pool.

4. The method of claim 1, wherein the LTE sensing information further indicates a priority of the reserved LTE SL resources of the another WTRU.

5. The method of claim 1, wherein the excluding the NR SL candidate resource is further based on an RSRP measurement of the reserved LTE SL resources of the another WTRU being greater than an RSRP threshold, wherein the RSRP threshold is based on at least one of: a priority of a NR SL transport block, a priority of an overlapped reserved LTE SL resource of the another WTRU, and the received RSRP threshold information.

6. The method of claim 1, wherein time and frequency resources of the excluded NR SL candidate resource overlaps with time and frequency resources of an LTE SL synchronization signal (SSS).

7. The method of claim 1, wherein the selecting NR SL candidate resources is in response to received trigger information.

8. The method of claim 1, wherein the excluding a NR SL candidate resource from the selected NR SL candidate resources is further based on the excluded NR SL candidate resource overlapping with at least one of the reserved LTE SL resources of the another WTRU.

9. The method of claim 1, wherein excluding a NR SL candidate resource from the selected NR SL candidate resources is based on a priority of a NR SL transport block or a priority of a reserved LTE resource.

10. The method of claim 1, wherein the LTE sensing information comprises at least one of: LTE SL synchronized signal block (SSB) resources, received LTE SSB reference signal receive power (RSRP), resources reserved for an LTE V2X transmission by the WTRU, resources reserved for an LTE V2X transmission intended for the WTRU, resources reserved for an LTE V2X transmission not intended for the WTRU, and RSRPs for the resources reserved for the LTE V2X transmission not intended for the WTRU.

11. A wireless transmit/receive unit (WTRU) comprising:
a receiver;
a transmitter; and
a processor; wherein:
the receiver is configured to receive configuration information indicating reference signal received power (RSRP) threshold information;
the processor is configured to select New Radio (NR) sidelink (SL) candidate resources, from a NR SL resource pool, for a hybrid automatic repeat request (HARQ)-enabled NR SL transmission, based on Long Term Evolution (LTE) sensing information, wherein the LTE sensing information indicates reserved LTE SL resources of another WTRU;
the processor is further configured to determine a NR SL physical SL feedback channel (PSFCH) resource associated with each NR SL candidate resource of the selected NR SL candidate resources;
the processor is further configured to exclude a NR SL candidate resource from the selected NR SL candidate resources, wherein the excluded NR SL candidate resources has an associated NR SL PSFCH resource that overlaps with at least one of the reserved LTE resources of the another WTRU;
the processor is further configured to select a NR SL resource within remaining NR SL candidate resources; and
the transmitter is configured to transmit information in a NR SL physical sidelink shared channel (PSSCH) transmission in the selected NR SL resource.

12. The WTRU of claim 11, wherein the received configuration information comprises at least one of: LTE SL sub-carrier spacing information, NR SL sub-carrier spacing information, a number of physical resource blocks (PRBs) for an LTE SL sub-channel, a number of PRBs for a NR SL sub-channel, LTE SL synchronization signal (SSS) resource configuration information, and NR SL PSFCH resource configuration information.

13. The WTRU of claim 11, wherein the processor is further configured to determine an association between time and frequency resources of an LTE SL resource pool and time and frequency resources of the NR SL resource pool.

14. The WTRU of claim 11, wherein the LTE sensing information further indicates a priority of the reserved LTE SL resources of the another WTRU.

15. The WTRU of claim 11, wherein the processor is further configured to exclude the NR SL candidate resource based on an RSRP measurement of the reserved LTE SL resources of the another WTRU being greater than an RSRP threshold, wherein the RSRP threshold is based on at least one of: a priority of a NR SL transport block, a priority of an overlapped reserved LTE SL resource of the another WTRU, and the received RSRP threshold information.

16. The WTRU of claim 11, wherein time and frequency resources of the excluded NR SL candidate resource overlaps with time and frequency resources of an LTE SL synchronization signal (SSS).

17. The WTRU of claim 11, wherein the processor is further configured to select NR SL candidate resources in response to received trigger information.

18. The WTRU of claim 11, wherein the processor is further configured to exclude a NR SL candidate resource from the selected NR SL candidate resources based on the excluded NR SL candidate resource overlapping with at least one of the reserved LTE SL resources of the another WTRU.

19. The WTRU of claim 11, wherein the processor is further configured to exclude a NR SL candidate resource from the selected NR SL candidate resources based on a priority of a NR SL transport block or a priority of a reserved LTE resource.

20. The WTRU of claim 11, wherein the LTE sensing information comprises at least one of: LTE SL synchronized signal block (SSB) resources, received LTE SSB reference signal receive power (RSRP), resources reserved for an LTE V2X transmission by the WTRU, resources reserved for an LTE V2X transmission intended for the WTRU, resources reserved for an LTE V2X transmission not intended for the WTRU, and RSRPs for the resources reserved for the LTE V2X transmission not intended for the WTRU.
